(19) United States
(12) Patent Application Publication
(10) Pub. No.: US 2006/0025211 A1
(43) Pub. Date: Feb. 2, 2006

(54) Gaming system constructions and methods

(76) Inventors: Peter B. Wilday, Reno, NV (US); Larry J. Woolf, Las Vegas, NV (US)

Correspondence Address: ELLIS & VENABLE, PC, 101 NORTH FIRST AVE., SUITE 1875, PHOENIX, AZ, 85003, US

(21) Appl. No.: 10/909,056

(22) Filed: Jul. 30, 2004

(51) Int. Cl. G06F 19/00

(52) U.S. Cl. 463/27

(57) ABSTRACT

A slot play stimulator is described including a gaming system for progressive jackpots comprising a plurality of gaming machines and a progressive jackpot system having a start show signal; a themed area construction comprising a canopy and at least one stand coupled to the plurality of gaming machines; a slot play stimulator system comprising: at least one auditory stimulator system; at least one ocular stimulating system; and at least one other stimulating system selected from the group consisting of a tactile stimulating system, an olfactory stimulating system, at least one dynamic model system and combinations thereof; and a show control system comprising a controller coupled to the gaming system and coupled to the slot play stimulator system.

### FIELD OF THE INVENTION

The present invention relates to the field of gaming constructions, and specifically to slot play stimulator constructions comprising gaming systems in which a progressive jackpot is utilized.

### BACKGROUND

Various games of skill and chance are well known and can be used under a variety of circumstances. Gaming machines include a variety of games; for example, slot, keno, poker, etc. Gaming machines can also be programmed to play a variety of games. These gaming machines typically require a monetary amount to be entered into the gaming machine before play begins. For example; players may insert coin, token, paper currency, magnetic cards, or other suitable entry credits, such as digital signals representing a monetary amount, into the gaming machine. Such operation of gaming machines is well know.

After entry of a monetary amount, a gaming machine calculates the bet, and determines from the bet the game(s) and/or awards that the player is participating in and/or qualifies for based on the gaming machine's internal game and associated pay tables. Typically, the player is required to take some affirmative action to begin the playing of the gaming machine. Such operation of gaming machines is well known.

In order to attract more players to such gaming machines progressive gaming systems were developed. In a progressive gaming system, individual gaming machines are linked together to allow players to compete for additional common awards, also called progressive jackpots. Progressive gaming systems are well known and are found throughout the world. For example, progressive gaming systems typically comprise a controller linked to the gaming machines. The controller receives information from each machine regarding the bets and supplies to the players information as to the common progressive jackpot. In one example of a progressive jackpot system, the controller randomly establishes a jackpot-win value. When the common progressive jackpot is equal to or exceeds the jackpot-win value, the controller determines that the jackpot has been won by the gaming machine on which the bet was placed that caused the jackpot-win value to be exceeded. The controller then communicates this information to the winning gaming machine and pays the player the winning amount. Such operations of gaming machines are well known, and are postulated to add excitement to the game and attract players.

A need exists, however, to improve in attracting players, retaining players and extending play at the gaming machines of a progressive gaming system. A need exist to provide players with a feeling of group participation, group entertainment, and group interaction with the progressive gaming system. A need also exist to increase a player's comfort in relation to the progressive gaming systems. A need also exists to reducing monitoring devices in a gaming area.

Information relevant to address these needs can be found in U.S. Pat. and patent Publication Nos. 6,656,048; 6,565,434; 6,502,800; 6,319,125; 6,270,410; 6,217,448; 6,146,273; 5,409,296; 5,344,144; 5,102,192; 4,964,638; 2004/0002375; 2004/0002709; 2003/0162582; 2003/0148807; 2003/0003988; and 2002/0160826 each of the foregoing in United States patent and patent Publication Nos. is hereby incorporated herein by reference. Each one of these referenced items, however, suffers from one or more of the following disadvantages.

One disadvantage is that they do not have a canopy to increase the feeling or group participation

Another disadvantage is that they do not incorporate a slot play stimulator system comprising an auditory system, an ocular system, and an other stimulating system.

Another disadvantage is that they do not supply gases or aromas.

Another disadvantage is that they the do not a seating device so that a player's feet may rest on floor.

Another disadvantage is that they do not have a show control system to sequence special effects to create a jackpot show including audio, visual and some other stimulating system.

Another disadvantage is that they do not include a method enhancing casino security field of view.

Another disadvantage is that they do not reduce the height of the stand and gaming machines so the buttons of the gaming machines are at wrist level when using a seating device such that the player's feet can sit flat on the floor.

### SUMMARY

It is an object of the present invention to provide a slot play stimulator construction. The slot play stimulator includes a gaming system for progressive jackpots comprising: a plurality of gaming machines and a progressive jackpot system having a start show signal; a themed area construction comprising a canopy and at least one stand coupled to the plurality of gaming machines; a slot play stimulator system comprising: at least one auditory stimulator system; at least one ocular stimulating system; and at least one other stimulating system selected from the group consisting of a tactile stimulating system, an olfactory stimulating system, at least one dynamic model system and combinations thereof; and a show control system comprising a controller coupled to the gaming system and coupled to the slot play stimulator system. Preferably, the at least one of the gaming machines is at least partially below the canopy, and the slot play stimulator system is coupled to the themed area construction; and the show control system receives the start show signal and the controller controls the slot play system. Preferably, the plurality of gaming machines are below the canopy. More preferably, the seating device that allows the player's feet to rest flat on the floor if so desired and more preferably the machine buttons are machine buttons of the gaming machines are at a height near the player's wrist level when the player is seated in a seating device that allows the player's feet to rest flat on the floor if so desired. Also preferably, the at least one stand has a height of less than 23 inches, and more preferably be the at least one stand has a height between 23 inches and 13 inches and most preferably the at least one stand comprises individual stands for each gaming machines. In one preferred embodiment, the slot play stimulator construction further comprises a plurality of seating devices and more preferably the seating devices have a floor to seat height of about 18½ inches.

Another embodiment of the invention includes a gas supply gaming combination comprising a gaming machine coupled with an gas supply device. Preferably, the gas supply gaming combination comprises a gas regulating device and a coupler, and preferably the coupler couples to a player's mask. More preferably the gas supply gaming combination further comprises at least one stand less having a height less than 23 inches.

Another embodiment of the invention includes a method of enhancing casino security field of view comprising the steps of coupling a plurality of gaming machine to at least one stand preferably comprising a height of less than 23 inches, such that the height of the gaming machines is reduced, and placing the coupled stand-gaming machines within a gaming area to increase visibility. Preferably, the method of enhancing casino security field of view further comprises the step of pairing at least one of the plurality of gaming machines with at least one of a plurality of seating devices having a floor to seat height of less than 19½ inches.

The invention also includes a method of reducing monitoring devices in a gaming area comprising the steps of coupling a plurality of gaming machine to at least one stand comprising a height of less than 23 inches and placing the coupled stand-gaming machines within a gaming area to increase visibility. Preferably, the method of reducing monitoring devices in a gaming area further comprise the step of pairing at least one of the plurality of gaming machines with at least one of a plurality of seating devices having a floor to seat height of less than 19½ inches.

The invention also describes a method of stimulating slot play comprising the steps of: designing a themed area construction comprising a canopy and at least one stand for a gaming system; coupling the themed area construction to a slot play stimulator system comprising: at least one auditory stimulator system; at least one ocular stimulating system; and at least one other stimulating system selected from the group consisting of a tactile stimulating system, an olfactory stimulating system at least one dynamic model system and combinations thereof; and coupling a gaming system for progressive jackpots comprising: a plurality of gaming machines and a progressive jackpot system having a start show signal plurality of gaming machines to the coupled theme area-slot play stimulator system; and coupling a show control system comprising a controller coupled to the gaming system to the slot play stimulator system; wherein at least one of the gaming machines is at least partially below the canopy, and wherein the slot play stimulator system is coupled to the themed area construction; and wherein the show control system receives the start show signal and the controller controls the slot play system. More preferably, the stand is chosen so that machine buttons of a gaming machine are at about a player's wrist level when the player is seated in a seating device having the height of a seat above a floor selected so that the player's feet may rest on the floor. More preferably, the height above the floor of the seat is adjustable and the soles of the player's feet, whether covered by shoes or not, may be flat on the floor.

Another embodiment of this invention includes a method of making a plurality of gaming machines accessible to wheelchair players comprising the steps of: coupling at least one at least one stand comprising a height of less than 23 inches to the plurality of gaming machines and placing the coupled stand gaming machines with a seating device having a floor to seat height less than 19½ inches and moving the seating device so the player in the wheelchair can access the plurality of gaming machines. In a preferred embodiment the step of placing the coupled stand gaming machines with the seating device comprises the seating device has a floor to seat height of about 18½ inches. Preferably, the step of: placing the coupled stand gaming machines with the seating device comprises the seating device having a capacity to seat less than 4 players; more preferably, comprises the seating device having a capacity to seat an individual player; and most preferably, comprises a movable chair having the capacity to seat an individual player and wherein the step of coupling at least one at least one stand to the plurality of gaming machines comprises at least one stand having a height less than 23 inches and, more preferably, of between 23 and 13 inches. In another embodiment of this invention includes a method of making a plurality of gaming machines accessible to wheelchair players comprising the steps of: coupling at least one at least one stand to the plurality of gaming machines and placing the coupled stand gaming machines with a seating device wherein the stand is chosen so that machine buttons of a gaming machine are at about a player's wrist level when the player is seated in a seating device having the height of a seat above a floor selected so that the player's feet may rest on the floor and moving the seating device so the player in the wheelchair can access the plurality of gaming machines. More preferably, the height above the floor of the seat is adjustable and the soles of the player's feet, whether covered by shoes or not, may be flat on the floor.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 sets forth one preferred embodiment of the invention showing a themed area construction, a gaming system and a slot play stimulator system

FIG. 2 sets forth a block diagram one preferred embodiment of the invention showing a gaming system, a show control system and a slot play stimulator system

FIG. 3 sets forth a block diagram showing the coupling in one preferred embodiment of the invention.

FIG. 4 shows one preferred embodiment of a chair including a gaming machine, a stand, an oxygen dispenser and a chair

FIG. 5 shows one preferred embodiment a gaming machine, a stand, and two preferred embodiments of the gas supply device.

FIG. 6 shows a preferred embodiment of a dynamic model system.

### DESCRIPTION

The present invention stimulates use of gaming machines by players in a variety of ways.

Preferred embodiments of slot play stimulation inventions that may be used alone or in various combinations will be described below.

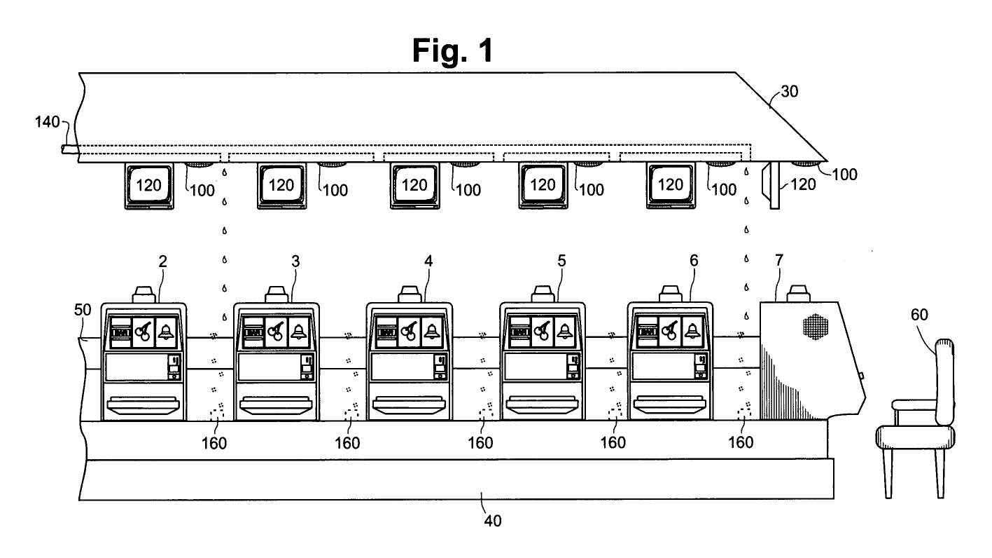

FIG. 1, one preferred embodiment of the invention, shows a plurality of gaming machines 2-7 (shown) and additional gaming machines (not shown) which are adapted for use with the themed system comprising; for example, a canopy 30, a stand 40, a negative edge pool 50 and, a suitable seating device 60; for example, in one preferred embodiment a chair. As illustrated each of the gaming machines; for example, may be any type of suitable gaming machine that may be coupled together including, but not limited to, slot machines, video poker machines, video keno machines, etc. FIG. 1 also shows a portion of a preferred embodiment of slot play stimulator system; for example, the auditory system comprises at least a speaker 100, the ocular system comprises at least a video display monitor 120 and the other system comprises at least a water display system including a water tube system 140 for simulating rain, an air bubbling system 160 in the pool, and other well known pool related equipment (not shown) such as filters, controllable valves, and air and water pumps. More preferably, the ocular system would also contain a lighting system (not shown).

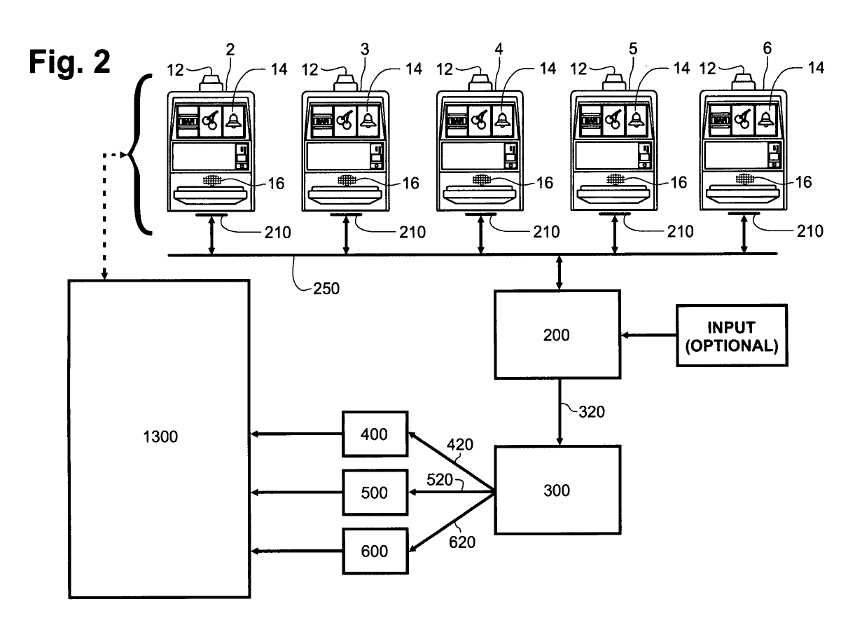

FIG. 2 illustrates gaming machines 2-7 (shown) and additional gaming machines (not shown) are interconnected to a controller 200 over a communications network 250 that may be wired or wireless. Any suitable communication network 250 could be used under the teachings of this invention; for example, any suitable serial or parallel bus arrangement could be used. Typically, at each gaming machine is an interface card 210 that interfaces with between the conventional circuitry of the gaming machines and the communications network 250. The design and operation of the slot machines is well known, and may be purchased from many companies such as Mikohn, Bally, etc. Further, controller 200 may be any suitably computer-based controller such as any number of different controllers and computer based processing systems. The design in which the controller 200 communicates with each of the gaming machines over the communications network may be chosen by the based on the protocols of communication as determined by the communication network 250 and the interface circuits 210.

FIG. 2 shows one preferred embodiment in which each of the conventional gaming machines also each have an independent tower lamp 12, an independent display 14, and an independent speaker 16. Each independent display 14 and independent speaker 16 that provide a visual and audible indications to the player at an individual gaming machine, such as in the given example gaming machine 2. FIG. 2 additionally shows that the controller 200 is coupled to a show controller 300 that control the auditory system 400, the ocular system 500 and the other stimulating system 600. Preferably the controller 200 interfaces with the show controller 300, and more preferably interfaces through a wired or wireless network, and most preferrably using interconnected lines 320. In one preferred embodiment, the show controller 300 is coupled to the auditory system 400, the ocular system 500, and the other stimulating system 600 using preferably, respectively, interconnected lines 420, 520 and 620. It is to be expressly understood that show controller 300 is conventionally available and is designed to present a show from a suitable programmable instructions, databases or other auxiallary media and multimedia storage devices using the slot play stimulator system. The actual construction and design of the show controller 300, the auditory system 400, the ocular system 500 and the other stimulating system 600, can be can be any number of designs. Show controllers and related equipment are well known; for example, Alcorn McBride, Inc. (3300 South Hiawassee, Orlando, Fla. 32835), has a wide variety of show controllers and related equipment. In a particularly preferred embodiment, the show controller is V4+ unit made by Alcorn McBride, Inc. The preferred embodiment also includes DMX machine and other equipment that may coupled to the show controller. In a particularly preferred embodiment, the programming instructions may be made using computer program known as WinScript and available from Alcorn McBride, Inc. The following comments illustrate one preferred embodiment of pseudoprogramming steps that may programmed:

### Sequence for One Preferred Embodiment of Storm Slots

NAME: COMMENT
Default: Set variable on start up
Display: Displays what mode you are in
Variabless: Select in sequence from 3 60 Second Audio Clips
SEQ 1: Start Show Signal triggers sequence
Output: Output relay triggers rain
Playlight 1: After 12 seconds lightcue 1 played
Playlight 2: After 23 seconds lightcue 2 played
Playlight 3: After 35 seconds lightcue 3 played
Playlight 4: After 60 seconds lightcue 4 Nullmode show normal mode
played
Bigswitch on: Input 3 Start Live from Cabaret
Bigswitch off: Input 3 Stop Live from Cabaret
RESET: Reset
Extron preset 1: Pool Normal Offmode
Extron preset 2: Pool when show starts
Extron preset 3: Live feed
Extron preset 4: Not live
Extron norm: Puts rest of Extron in Normal Mode

It is to be understood that the type of instructions and triggers may be chosen based on protocols of the show controller, the software, the auditory systems, the ocular systems and the other systems. Another preferred embodiment would be to design the controller 300 to also perform the tasks of the show controller 400. In which case, the start show signal would be internally generated in the controller, and the controller would directly drive the auditory system 400, the ocular system 500 and the other stimulating system 600. In another preferred embodiment, two or more of the auditory system 400, the ocular system 500 and the other stimulating system 600 might be combined; for example, a television having a speaker could combine the auditory system and the ocular system. It is to be understood that the actual construction and design of the show controller 300, the auditory system 400, the ocular system 500 and the other stimulating system 600, can be can be any number of designs depending on the components chosen.

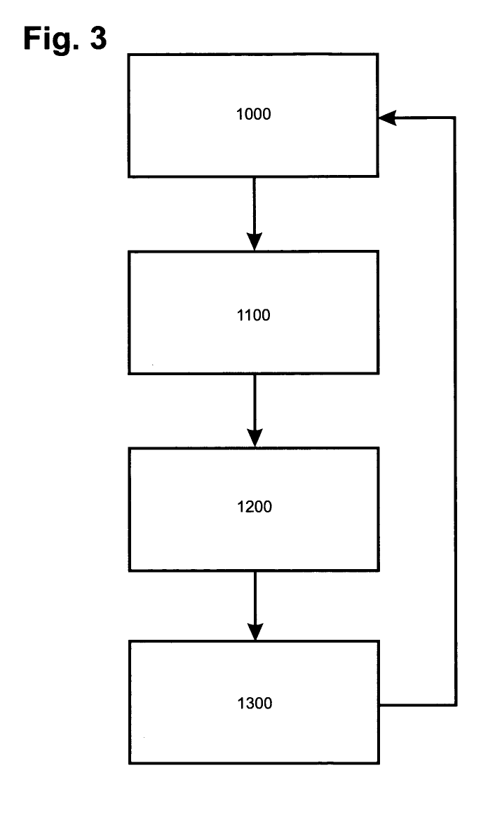

FIG. 3 shows a block diagram of one preferred embodiment of the invention wherein the gaming system 1000 is coupled to a themed area construction 1300 having a canopy, and the gaming system 1000 is coupled to the show controller 1100, the slot play stimulator system 1200 is coupled to the themed area construction. More preferably, the gaming system 1000 is interconnected to the show controller 1100, the show controller is interconnected with the slot play stimulator 1200, and the slot play stimulator 1200 and the gaming system are integrated with the themed area construction 1300. Most preferrably, the gaming system 1000, at least portions of the slot play stimulator 1200 are integrated with the themed area construction to provide stimulation to at least one player.

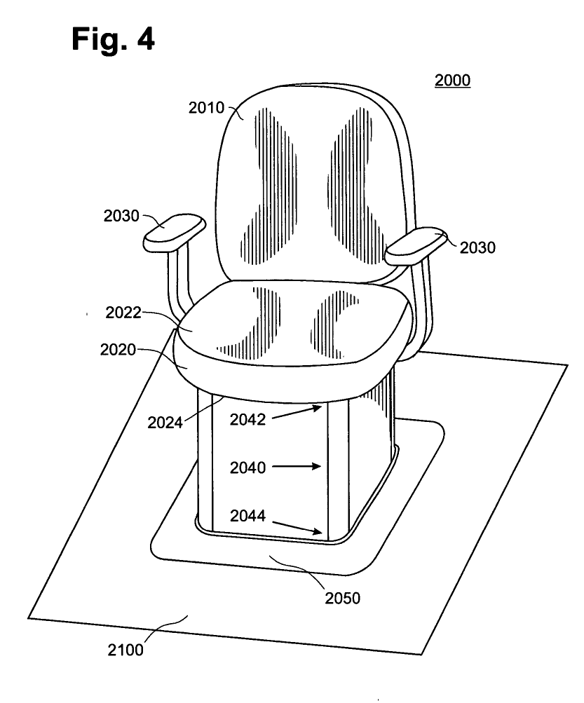

FIG. 4 shows a preferred embodiment of a seating device. Preferably the seating device has at least one seat and to at least one seat supporting device comprising a support end and a seat end wherein the seat is coupled to the seat end of the at least one seat supporting device and the support end supports the seat above a floor. It is to be understood that the seating device may be movable or fixed in relation to one or mor gaming machines. Preferably the seating device is movable.

For example, in the preferred embodiment of FIG. 4, the seating device is a chair 2000 having a back 2010, a seat 2020 having a top 2022 and bottom 2024, arm rests 2030, legs 2040 having seat end 2042 and a floor end 2044, and leg stablizer 2050 wherein the floor end 2044 and the leg stabilzers 2050 preferably contact the floor 2100. Preferably in the invention, the length of the legs are chosen so that the distance between the top 2022 of the seat 2020 and the floor 2100 allows for a player to sit with the player's feet flat on the floor 2100. More preferably, the distance between the top 2022 of the seat 2020 and the floor 2100 is chosen to be less than 19½ inches and most preferably, the distance between the top 2022 of the seat 2020 and the floor 2100 is chosen to be about 18½ inches.

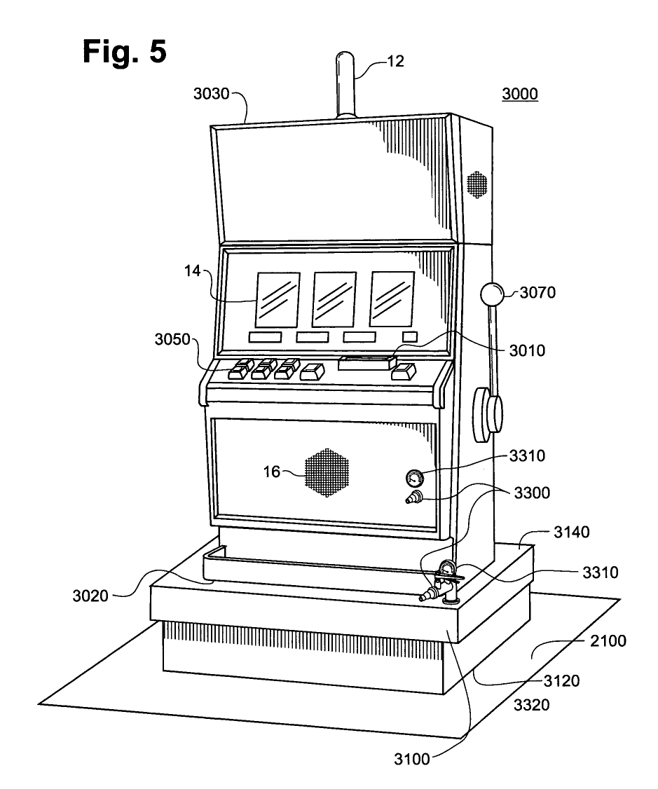

FIG. 5 shows one possible embodiment of one gaming machine 3000 and stand 3100. Gaming machines are well known and it is to be understood that any gaming machine may be used that adjusted with or without a stand so that the seating device of this invention may be used. For example, in a preferred embodiment a gaming machine may be used that does not require a coin drop box necessitating a stand 3100 greater than 23 inches. In this preferred embodiment, the gaming machine does not use coins and instead uses payment tickets or some other some other method of electronically transmitting a monetary wager to machines. The payment tickets may be inserted into the machines in though a ticket slot 3010. In this preferred embodiment the stand 3100 has a floor side 3120 and a game side 3140. In this particular embodiment, the gaming machine has a stand side 3020, a top 3030, a tower lamp 12, machine buttons 3050 to select a number of coins to be bet, select the type of game and/or select the start of the game, and a display 14 that may be either mechanical or more preferably a video display, and a speaker (not shown). Optionally, the gaming machine may have a lever 3070 to start the game. In the preferred embodiment of this invention, it is to be understood that a stand and its height are chosen to couple the game to the gaming machine so that the distance from the floor 2100 to the machine buttons 3050 are at wrist level when using a seating device wherein the player's feet may be flat on the floor 2100. In this preferred embodiment, the distance between the floor side 3120 and the game side 3140 is less than 23 inches. More preferably the distance between the floor side 3120 and the game side 3140 is between 13 and 23 inches.

FIG. 5 also shows another embodiment of the invention comprising a gas supply gaming combination 3300. The gas supply gaming combination 3300 in the present invention includes a gas supply device 3310 that may be mounted on a gaming machine, the stand or, less preferably, dropped from overhead near the gaming machine (not shown). Preferably, the gas supply device 3310 may supply gas to those players requesting such gas. As a preferable example the gas may be oxygen or air that may contain aromas such as those used in aroma therapy; most preferably the combination of gases and aromas could be selected by the player. It is to be understood that the composition of the gases and aromas are not limited to those listed found in above preferred embodiment; for example, other gases such as helium, nitrous oxide, etc. and other aromas might be chosen. Preferably, the gas is delivered through a mask device (not shown) including a mask and connecting tube so; for example, a player would not need to use portable oxygen bottles. Portable, and stationary, oxygen systems are used in hospitals, homes, automobiles, etc.

In a preferred embodiment, the gas supply device 3310 may deliver combinations of oxygen, air and aromas such as those aromas used in aroma therapy. While the mask devices could be permanently attached to the gas delivery system, most preferably, the mask devices could be coupled to gas delivery device 3310 and then removed. Such mask devices could be supplied by the player or the business proprietor. More preferably, the mask devices may be those commonly used with oxygen bottles. In one preferred embodiment, the player may select the type of gas and/or aromas to be delivered; for example, the player might select some aroma such as lavender, mint, etc. in combination with air and/or oxygen. In this preferred embodiment, the player's gas delivery selection could be limited by safety concerns. In another embodiment of this invention, the gas supply device 3310 could be coupled to the slot stimulator system 1200 such that the gas supply device becomes part of the other stimulation system. In another preferred embodiment, the gas and/or aromas may be programmed to change during a jackpot show.

Each of the following examples incorporates one or more of the invention.

1. Storm Slots

One preferred embodiment of this invention includes the gaming machines placed around a pool with water spilling over the edges where the pool is slightly elevated above top of the gaming machines so that the moving water reflects the colored lights of the casino beyond (see FIG. 1). In this embodiment, the players of the gaming machines are made more comfortable using a stand less than 23 inches high and a plurality of seating devices having a floor to seat height less than 19½ inches. In this preferred embodiment also includes a canopy over the gaming machines that are around the pool, speakers, lights, televisions, water tube systems, and air bubblers are placed so that they do not interfere with the reflections in the pool before or after the show, but may be used by the show triggered when a player wins the progressive jackpot (i.e. the “jackpot show”) it triggers the start show signal and causes the show control system to activate the slot play stimulator system that produces the jackpot show. In this preferred embodiment, the jackpot show comprises a simulation of thunder bellowing, lighting flashes, rain falling, and the water in the pool bubbling. Further, in this preferred embodiment, the televisions play special audio and video productions announcing the winning player. During the jackpot show, the rain simulation also stimulates the player by causing some air movement. In this embodiment, the jackpot show is triggered by a start show signal created by a player winning the progressive jackpot.

2. Bird Bar Slots

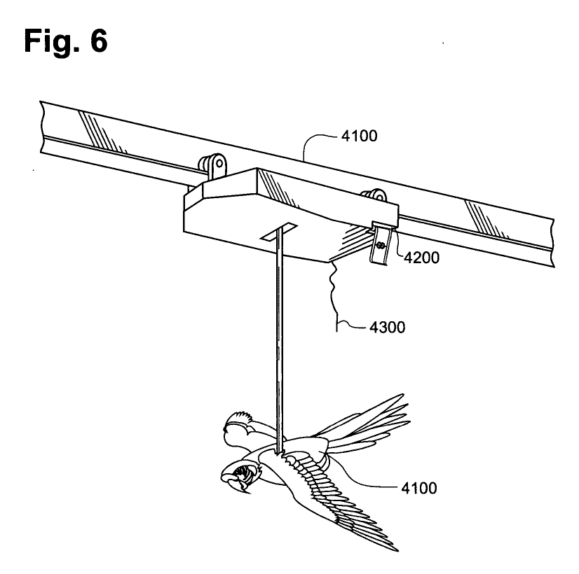

Another embodiment of the slot play stimulator system includes a themed area construction comprising placing the gaming machines around a bar having a thick trellis canopy of foliage over at least some of the gaming machines and/or players. In this preferred embodiment, bird models are located in the thick foliage, and preferably, bird sounds emanate at programmed times. In this preferred embodiment also includes a canopy over the gaming machines that are around the pool, speakers, lights, televisions, movable and fixed model birds, and jackpot meters to indicate the status of the jackpot. More preferably, other gaming machines located outside of the canopy and are connected gaming system. In a preferred embodiment of jackpot show in this invention, the following occurs: the lights under the canopy are turned off, the bird sounds increase dramatically, spot lights then highlight the birds under in the canopy, a mechanical bird model 4000 coupled to a track overhead 4100 begins its simulated flight and is equipped with a dispenser 4200 capable of dropping coupons or promotional dollars either at predetermined times or, in a more preferred embodiment, on command with a wireless remote controller (not shown) and antenna 4300 (see FIG. 6). Preferably the track can be of any material and configuration that can support the mechanical model; for example in a most preferred embodiment the track is an I-beam made of aluminum. Also preferably the movement along the track of mechanical model is provided by a model support having motorized wheels coupled to the I-beam; for example, the I-beam and model support having motorized wheels are similar to those used for motorized I-beam hoists and supports. In this preferred embodiment, at least one of the overhead televisions interrupts the programming to congratulate and identify the progressive jackpot winner; more preferably identifying the winner as the “Bird Bar Winner”. In this preferred embodiment, as the mechanical bird approaches the themed area, the bird sounds increase to a fevered pitch simulating that the mechanical bird is “calling the flock”. More preferably, the dispenser will drop promotional coupons and/or dollars to further stimulate the players below. After the mechanical bird passes the canopy, the lights and sounds then return to pre-show conditions and the mechanical bird continues on the track back to staging area (sometimes known as “the nest”) until the next winner of the “Bird Bar Winner”. In a more preferred embodiment, the players of the gaming machines are made more comfortable using a stand less than 23 inches high and a plurality of seating devices having a floor to seat height less than 19½ inches.

3. Volcano Slots

In another preferred embodiment of the slot play stimulator construction including a themed area comprises placing the gaming machines around a pool of water simulating an ocean. More preferably, the pool include a wave simulating system. A model of volcanic island, preferably having a crater at the top, rises out of the pool. In this preferred embodiment, the volcanic island is tropically decorated to simulate tropical settings such as tropical water streams and water falls that flow into the pool. This embodiment also includes a canopy having a tropical theme over the gaming machines that are around the pool and televisions are placed under the canopy so that they are visable to the gaming machine players but do not interfere with the jackpot show. In the preferred embodiment of this invention, at least some of the chairs contain vibration systems such as mechanical vibration systems or sound vibration systems. In a more preferred embodiment, the players of the gaming machines are made more comfortable using a stand less than 23 inches high and a plurality of seating devices having a floor to seat height less than 19½ inches. More preferably, the canopy also includes a blue domed ceiling having fiber optics to simulate the sky and stars. The pre-show conditions in this preferred embodiment, comprise softly playing music and standard television programming. In a preferred embodiment of jackpot show in this invention, at least one of the overhead televisions interrupt the programming to congratulate and identify the progressive jackpot winner and the following occurs: the pool and volcano begin to rumble and vibrate, the lights dim, volcano then simulates an eruption with smoke, the lights then flash and lava appears to shoot out of the crater; the tropical streams and waterfalls simulate lava flows that flow down into the pool where the water bubbles and appears to turn the water to steam. More preferably, at least one of the players chairs vibrate. In this preferred embodiment, the smoke is then exhausted from under canopy.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A slot play stimulator construction, comprising:
a) a gaming system for progressive jackpots comprising: a plurality of gaming machines and a progressive jackpot system having a start show signal;
b) a themed area construction comprising a canopy and at least one stand coupled to the plurality of gaming machines;
c) a slot play stimulator system comprising: at least one auditory stimulator system; at least one ocular stimulating system; and at least one other stimulating system selected from the group consisting of a tactile stimulating system, an olfactory stimulating system, at least one dynamic model system and combinations thereof; and
d) a show control system comprising a controller coupled to the gaming system and coupled to the slot play stimulator system;
wherein at least one of the gaming machines is at least partially below the canopy, and wherein the slot play stimulator system is coupled to the themed area construction; and wherein the show control system receives the start show signal and the controller controls the slot play system.

2. The slot play stimulator construction of claim 1 wherein the plurality of gaming machines are below the canopy.

3. The slot play stimulator construction of claim 1 wherein the at least one stand has a height of less than 23 inches.

4. The slot play stimulator construction of claim 3 further comprising a plurality of seating devices having a floor to seat height of less than 19½ inches.

5. The slot play stimulator construction of claim 3 further comprising a plurality of seating devices having a floor to seat height of about 18½ inches.

6. The slot play stimulator construction of claim 1 wherein the at least one stand has a height between 23 inches and 13 inches.

7. The slot play stimulator construction of claim 6 further comprising a plurality of seating devices having a floor to seat height of less than 19½ inches.

8. The slot play stimulator construction of claim 6 further comprising a plurality of seating devices having a floor to seat height of about 18½ inches.

9. The slot play stimulator construction of claim 1 further comprising a plurality of seating devices having a seat at a height above a floor so that a sole of a player's foot may be placed on the floor.

10. The slot play stimulator construction of claim 9 wherein the height of the seat is adjustable.

11. The slot play stimulator construction of claim 10 wherein the at least one stand has a height selected so that the machine buttons are at a player's wrist level.

12. The slot play stimulator construction of claim 11 wherein the height of the machine buttons are adjustable.

13. The slot play stimulator construction of claim 1 wherein the at least one stand comprises individual stands for each of the plurality of gaming machines.

14. The slot play stimulator construction of claim 13 wherein the at least one of the stands has a height of less than 23 inches.

15. The slot play stimulator construction of claim 14 wherein the at least one stand has a height between 23 inches and 13 inches.

16. The slot play stimulator construction of claim 15 further comprising a plurality of seating devices having a floor to seat height of less than 19½ inches.

17. The slot play stimulator construction of claim 16 wherein the plurality of seating devices are movable chairs.

18. The slot play stimulator construction of claim 1 wherein the at least one auditory system comprises a water noise and thunder simulation system; the at least one ocular simulation system comprises a pool and a lightning simulation system; and the other simulation system comprises a rain simulation system and a water bubbling system.

19. The slot play stimulator construction of claim 18 wherein the plurality of gaming machines surround the pool.

20. The slot play stimulator construction of claim 19 wherein the at least one auditory system and the at least one ocular simulation system further comprise an audio-visual display system.

21. The slot play stimulator construction of claim 20 wherein audio-visual display system is at least one television.

22. The slot play stimulator construction of claim 1 wherein the at least one auditory system comprises a bird noise simulation system; the at least one ocular simulation system comprises a bird model and lighting system; and the other simulation system comprises at least one dynamic model system.

23. The slot play stimulator construction of claim 22 wherein the at least one dynamic model system comprises at least one controllable model capable of movement.

24. The slot play stimulator construction of claim 23 wherein the at least one controllable model capable of movement comprises a model system movable coupled to a track.

25. The slot play stimulator construction of claim 24 wherein the model system comprises a model and a model support wherein the model support is coupled to the model and the model support is coupled to the track.

26. The slot play stimulator construction of claim 25 wherein the model system comprises a model and a model support and a model movement system wherein the model support is coupled to the model and the model support is coupled to the track.

27. The slot play stimulator construction of claim 26 wherein the model movement system comprises a drive system and a drive controller coupled to the show controller.

28. The slot play stimulator construction of claim 27 wherein the model has at least one movable part and the movement system further comprises a model movement devices coupled to the at least one movable part and the drive controller is coupled to the model movement devices.

29. The slot play stimulator construction of claim 28 wherein the model is a bird having wings connected to a body, the at least one movable parts are the wings, and the model movement devices are electric motors.

30. The slot play stimulator construction of claim 26 wherein the track is an I-beam.

31. The slot play stimulator construction of claim 23 wherein the dynamic model system comprises a dispensing device.

32. The slot play stimulator construction of claim 31 wherein the dispensing device further comprises a separate remote controller.

33. The slot play stimulator construction of claim 1 wherein the at least one auditory system comprises a tropical island simulation system; the at least one ocular system comprises a volcanic island and lighting system; and the other simulation system comprises a volcanic eruption system.

34. The slot play stimulator construction of claim 33 wherein the volcanic eruption system comprises a lava and smoke simulation system.

35. The slot play stimulator construction of claim 34 wherein the volcanic eruption system further comprises a vibration generation system.

36. A slot play stimulator construction comprising at least one stand comprising a height of less than 23 inches coupled to a plurality of gaming devices and a plurality of seating devices having a floor to seat height of less than 19½ inches.

37. The slot play stimulator construction of claim 36 wherein the at least one stand has a height between 23 inches and 13 inches.

38. The slot play stimulator construction of claim 36 further comprising a plurality of seating devices having a floor to seat height about 18½ inches.

39. The slot play stimulator construction of claim 36 wherein the at least one stand comprises individual stands for each gaming machines.

40. The slot play stimulator construction of claim 39 wherein the plurality of seating devices are movable chairs for individual players.

41. The slot play stimulator construction of claim 40 wherein the plurality of seating devices is equal to the plurality of gaming machines.

42. A slot play stimulator construction comprising at least one stand comprising a height selected so that the machine buttons are at about a player's wrist level coupled to a plurality of gaming devices and a plurality of seating devices having a seat at a height above a floor so that a sole of a player's foot or shoe may be placed on the floor.

43. The slot play stimulator construction of claim 42 wherein the height of the seat is adjustable.

44. An gas supply gaming combination comprising a gaming machine coupled with an gas supply device.

45. The gas supply gaming combination of claim 44 wherein the gas supply device comprises an oxygen regulating device and a coupler.

46. The gas supply gaming combination of claim 45 wherein the gas supply device comprises is mounted on the gaming machine.

47. The gas supply gaming combination of claim 45 wherein the gas supply device comprises is mounted on the stand.

48. The gas supply gaming combination of claim 45 wherein the gas supply device supplies a breathable gas.

49. The gas supply gaming combination of claim 48 wherein the breathable gas is comprises oxygen, air, aromas and combinations thereof.

50. The gas supply gaming combination of claim 48 further comprises a control valve to select compositions of the breathable gas.

51. The gas supply gaming combination of claim 50 wherein the control valve is coupled to the show control system.

52. A method of enhancing casino security field of view comprising the steps of coupling a plurality of gaming machine to at least one stand comprising a height of less than 23 inches and placing the coupled stand-gaming machines within a gaming area to increase visibility.

53. The method of enhancing casino security field of view in claim 52 further comprising the step of pairing at least one of the plurality of gaming machines with at least one of a plurality of seating devices having a floor to seat height of less than 19½ inches.

54. The method of enhancing casino security field of view in claim 53 further comprising the step of pairing the plurality of gaming machines with the plurality of seating devices having an adjustable floor to seat height of about 18½ inches.

55. A method of reducing monitoring devices in a gaming area comprising the steps of coupling a plurality of gaming machine to at least one stand comprising a height of less than 23 inches and placing the coupled stand-gaming machines within a gaming area to increase visibility.

56. The method of reducing monitoring devices in a gaming area in claim 55 further comprising the step of pairing at least one of the plurality of gaming machines with at least one of a plurality of seating devices having a floor to seat height of less than 19½ inches.

57. The method of reducing monitoring devices in a gaming area in claim 56 further comprising the step of pairing the plurality of gaming machines with the plurality of seating devices having an adjustable floor to seat height of about 18½ inches.

58. A method of stimulating slot play for players comprising the steps of:
a) coupling the themed area construction comprising a canopy and at least one stand for a gaming system to a slot play stimulator system comprising: at least one auditory stimulator system; at least one ocular stimulating system; and at least one other stimulating system selected from the group consisting of a tactile stimulating system, an olfactory stimulating system, at least one dynamic model system and combinations thereof; and
b) coupling a show control system comprising a controller for to activate the slot play stimulator system; and
c) coupling a gaming system for progressive jackpots comprising: a plurality of gaming machines for placing bets and a progressive jackpot system having a start show signal to the show control system;
wherein the progressive jackpot system activates the start show signal.

59. A method of making a plurality of gaming machines accessible to players in wheelchairs comprising the steps of: coupling at least one at least one stand comprising a height of less than 23 inches to the plurality of gaming machines and placing the coupled stand gaming machines with a seating device having a floor to seat height less than 20 inches and moving the seating device so the player in the wheelchair can access the plurality of gaming machines.

60. The method of making a plurality of gaming machines accessible to players in wheelchairs of claim 59 wherein the step of: placing the coupled stand gaming machines with the seating device comprises the seating device has a floor to seat height of about 18½ inches.

61. The method of making a plurality of gaming machines accessible to players in wheelchairs of claim 59 wherein the step of: placing the coupled stand gaming machines with the seating device comprises the seating device having a capacity to seat less than 4 players.

62. The method of making a plurality of gaming machines accessible to wheelchairs of claim 59 wherein the step of: placing the coupled stand gaming machines with a seating device comprises the seating device having a capacity to seat an individual player.

63. The method of making a plurality of gaming machines accessible to wheelchairs of claim 62 wherein the step of: placing the coupled stand gaming machines with a seating device comprises a movable chair having the capacity to seat an individual player and wherein the step of coupling at least one at least one stand to the plurality of gaming machines comprises at least one stand having a height of between 23 and 13 inches.
